(19) United States
(12) Patent Application Publication
(10) Pub. No.: US 2004/0242064 A1
(43) Pub. Date: Dec. 2, 2004

(54) Electrical connecting interface of removable data storage device

(76) Inventors: Che-Chia Chang, Jung-He City (TW); Allen Lin, Hsintien City (TW)

Correspondence Address: PRO-TECHTOR INTERNATIONAL, 20775 Norada Court, Saratoga, CA, 95070-3018, US

(21) Appl. No.: 10/640,749

(22) Filed: Aug. 13, 2003

(30) Foreign Application Priority Data
May 28, 2003 (TW) 92114371

(51) Int. Cl. H01R 13/73

(52) U.S. Cl. 439/564

(57) ABSTRACT

An electrical connecting interface of a removable data storage device is described. The electrical connecting interface electrically connecting a data storage unit with a host computer has an electrical connector disposed on a fixing unit of the removable data storage device. The electrical connector has cables to electrically connect with the host computer directly. Therefore, the electrical connecting interface improves electrical connection quality of the removable data storage device and the host computer by way of the direct electrical connection for transmitting data and power without any other interface requirement.

### FIELD OF THE INVENTION

The present invention relates to an electrical connecting interface of a removable data storage device and especially to an electrical connecting interface of a removable data storage device for directly transmitting data without any other interface requirement.

### BACKGROUND OF THE INVENTION

A hard disk drive is normally installed inside of a computer for storing data. A removable hard disk is of interest for safety and convenience. The removable hard disk can be withdrawn from a computer to back up data for data storage safety and inserted into another computer for operation therein.

A conventional removable hard disk module includes a hard disk, a removable hard disk container, and a fixed box. The hard disk includes a data connector and a power connector. The removable hard disk container includes an adapting connector disposed thereon, a printed circuit board (PCB), a data transmission cable with two data connectors, and a power cable with power connectors. The adapting connector is fixed on the printed circuit board along with one of the data transmission cable connectors. The fixed box includes a corresponding adapting connector mounted on a small PCB that also has a data connector and power connector mounted thereon. Therefore, a ribbon cable with two data connector is connected to the data connectors of the fixed box and the host computer, and a power cable is connected to the power connectors of the fixed box and the host computer while the conventional removable hard disk module is connected to the host computer.

The conventional removable hard disk module needs a lot of connectors, cables, printed circuit boards, and transformation units in addition to the removable hard disk container and the fixed box. Too many connectors not only induce inconvenience during assembly but also cause problems such as data loss and damage.

### SUMMARY OF THE INVENTION

One object of the present invention is to provide an electrical connecting interface of a removable data storage device for eliminating the foregoing inconveniences and problems. The electrical connecting interface according to the present invention directly transmits data and power, without any other interface requirement, for the removable data storage device.

To achieve these and other advantages and in accordance with the object of the invention, the present invention provides an electrical connecting interface of a removable data storage device having a electrical connector disposed on a fixing unit of the removable data storage device for direct electrical connection between a host computer and a data storage unit. The electrical connector includes cables for direct electrical connection to the host computer. Therefore, the data storage unit and the host computer connect directly to each other with the electrical connecting interface according to the present invention without any other interface requirement. Additionally, quality of the electrical connection can be enhanced by way of the direct electrical connection thereof with the direct data transmission.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic perspective view of the electrical connecting interface according to the present invention;

FIG. 2 is a schematic perspective view of the electrical connecting interface according to the present invention without a data storage device;

FIG. 3 is a schematic perspective view of the data storage device with corresponding connectors;

FIG. 4 is a schematic perspective view of the electrical connecting interface according to the present invention with cables connected; and

FIG. 5 is a schematic perspective view of the first housing and cables according to the present invention.

### DETAILED DESCRIPTION OF THE PREFERRED EMBODIMENT

The following description is the best presently contemplated mode of carrying out the present invention. This description is not to be taken in a limiting sense but is made merely for the purpose of describing the general principles of the invention. The scope of the invention should be determined by referencing the appended claims.

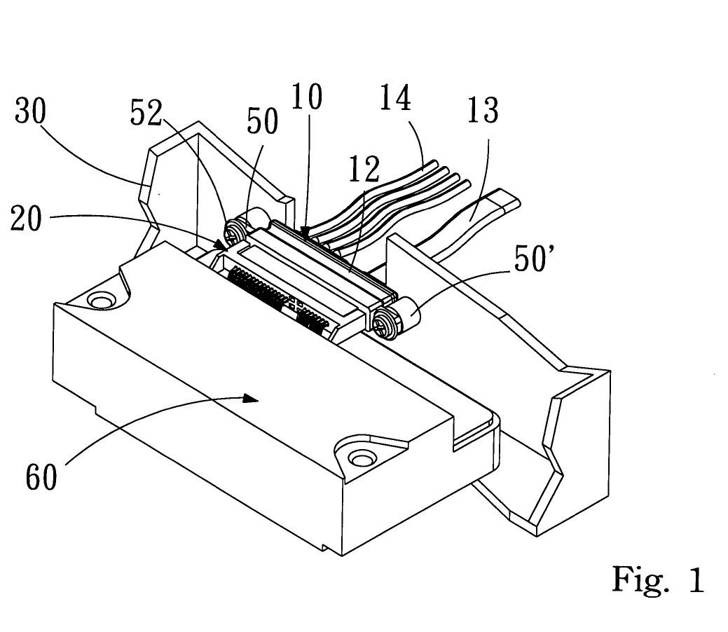

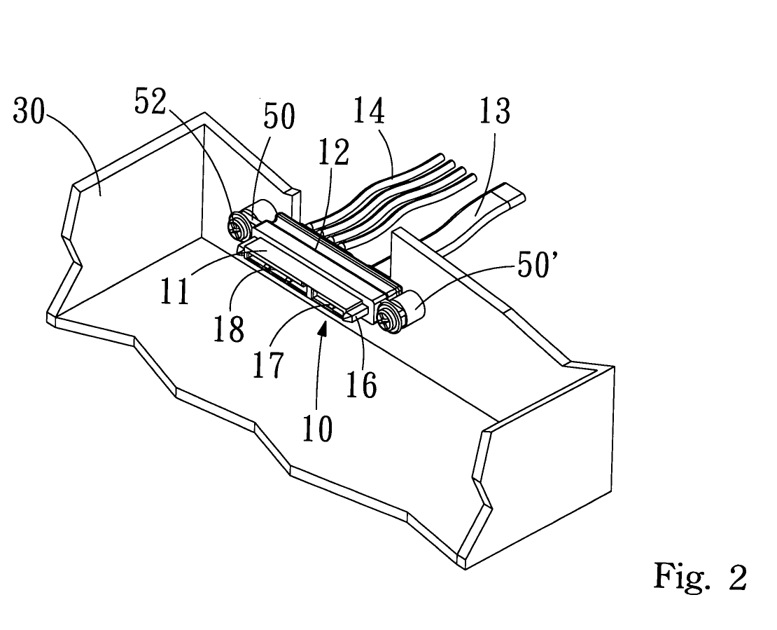

FIGS. 1 to 3 illustrate the schematic view of the electrical connecting interface according to the present invention and working statuses thereof. The present invention provides an electrical connecting interface of a removable data storage device for electrical connecting a host computer with a data storage unit. The host computer is a personal computer, an industrial server, or any other electric appliance. The removable data storage device includes a hard disk, a floppy, an optical disk drive, and so on. The electrical connecting interface of the removable data storage device comprises an electrical connector 10 disposed on a fixing unit 30 and a corresponding electrical connector 20 disposed on a data storage device 60 of a removable unit (not shown). Therefore, the electrical connector 10 and the corresponding electrical connector 20 directly electrically connect with each other to transmit data and power so as to enhance the electrical connection quality without any other interface requirements.

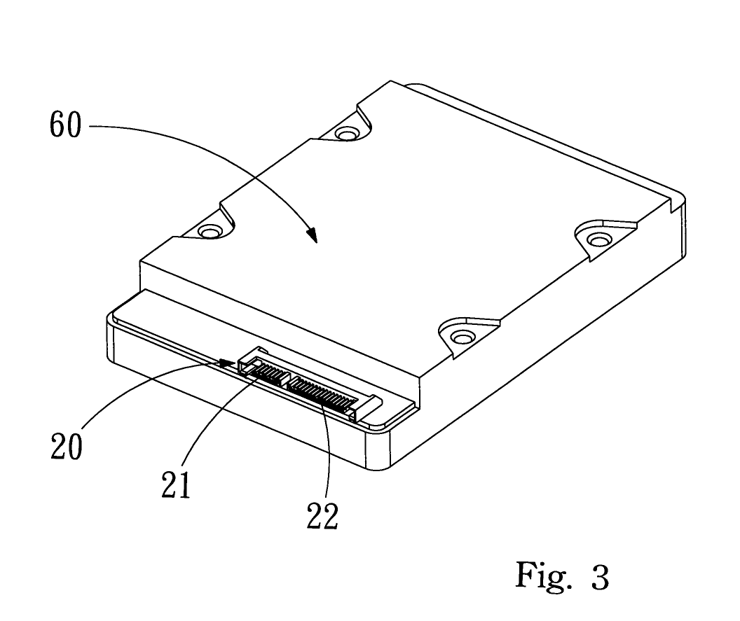

The electrical connector 10 and the corresponding electrical connector 20 are standard connectors obeying the serial advanced technology attachment (SATA) specification. The electrical connector 10 comprises a first connecting terminal 17 for transmitting data and a second connecting terminal 18 for supplying power. The first connecting terminal 17 and the second connecting terminal 18 further comprise a signal cable 13 and a power cable 14 respectively. Referring to FIG. 3, the corresponding electrical connector 20 further comprises a first corresponding connecting terminal 21 for transmitting data and a second corresponding connecting terminal 22 for supplying power.

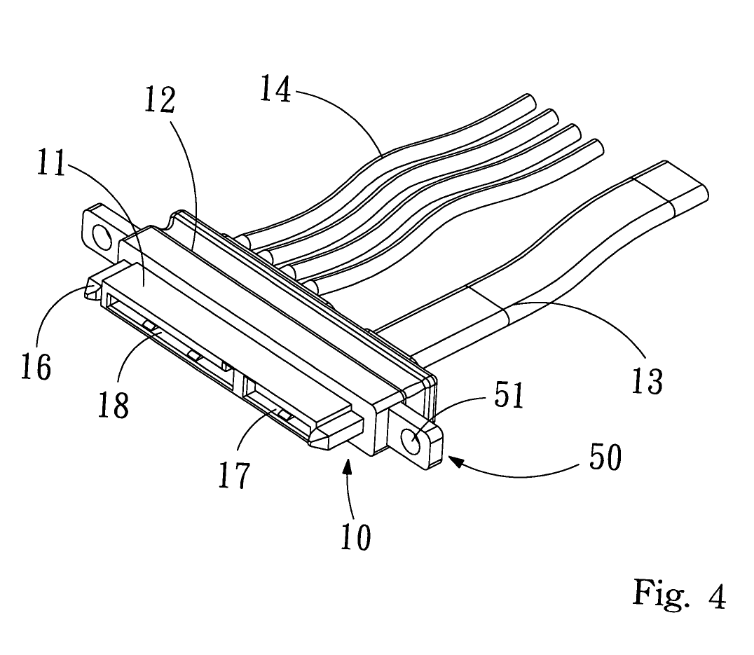

FIG. 4 illustrates a schematic view of the electrical connecting interface according to the present invention connecting with cables. The electrical connector 10 and the fixing unit 30 further comprise a pair of fixing sections 50 and 50′, respectively. The fixing section 50 of the electrical connector 10 includes a guiding hole 51 and the fixing section 50′ of the fixing unit 30 includes a stud. A fixing element 52 further firmly couples the electrical connector 10 to the fixing unit 30. The fixing section 50′ of the fixing unit 30 has a machined thread or an embedding nut. The fixing element 52 has a screw and furthermore the electrical connector 10 comprises guiding studs 16 to aid connection.

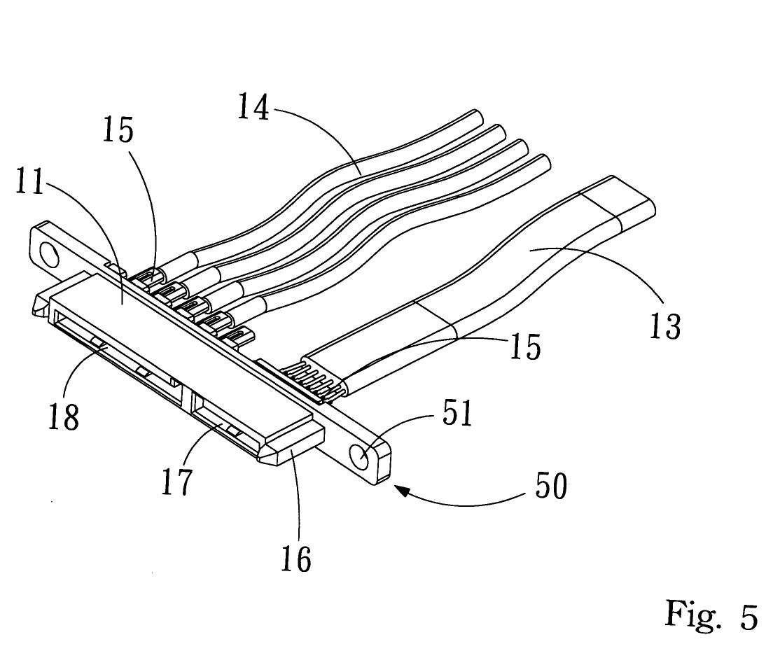

Referring to FIG. 4 and 5, for reducing manufacture procedures, the electrical connector 10 further includes a first housing 11 and a second housing 12. The contact terminals 15 insert into the first housing 11. The second housing 12 covers a part of the first housing 11, a part of the signal cable 13 and a part of the power cable 14. The first housing 11 is manufactured first. Then, the contact terminals 15 are inserted into the first housing 11. The signal cable 13 and the power cable 14 are electrically coupled with the contact terminals 15. The second housing 12 is formed in a plastic injection process to protect the contact terminals 15, the signal cable 13 and the power cable 14. The second housing 12 not only protects the electrical properties of the connector but also provides a perfectly firm connection.

Referring to FIG. 1, the fixing element 52 couples the fixing section 50 of the electrical connector 10 with the fixing section 50′ of the fixing unit 30 to construct a secure connection so as to create an electrical interface on the fixing unit 30. The signal cable 13 and the power cable 14 further couple to a signal connector and a power connector of the host computer. In the meantime, the data storage device 60 is fixed on a removable unit (not shown). The electrical connector 10 electrically couples with the corresponding electrical connector 20 while the removable unit is inserted into the fixing unit 30 with a predetermined procedure. Therefore, the present invention can improve a conventional interface with a complicated transformation structure and can also improve electrical signal interference problems therebetween to enhance the transmission quality.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An electrical connecting interface of a removable data storage device to connect electrically a host computer with a data storage unit, the electrical connecting interface comprising:
an electrical connector disposed on a fixing unit of a removable data storage device, wherein the electrical connector further comprises cables to connect directly and electrically the host computer with the data storage unit for enhancing the electrical connection quality.

2. The electrical connecting interface of a removable data storage device of claim 1, wherein the data storage device further comprises a fixing unit and a removable unit, the removable unit furthermore comprises a data storage unit and the data storage unit comprises a corresponding electrical connector complementary to the electrical connector.

3. The electrical connecting interface of a removable data storage device of claim 1, wherein the electrical connector is a standard connector of a serial advanced technology attachment type.

4. The electrical connecting interface of a removable data storage device of claim 1, wherein the electrical connector comprises a first connecting terminal for transmitting signals and a second connecting terminal for supplying power and the cables comprise a signal cable for transmitting the signals and a power cable for supplying the power.

5. The electrical connecting interface of a removable data storage device of claim 1, wherein the electrical connector comprises a first housing for inserting contact terminals and a second housing for covering a part of the first housing and a part of the cables.

6. The electrical connecting interface of a removable data storage device of claim 1, wherein the second housing is formed in a plastic injection process.

7. The electrical connecting interface of a removable data storage device of claim 1, wherein the electrical connector and the fixing unit comprise a pair of fixing sections.

8. The electrical connecting interface of a removable data storage device of claim 7, wherein the pair of fixing sections are fixed by a fixing element.

9. The electrical connecting interface of a removable data storage device of claim 7, wherein the fixing section of the electrical connector comprises a guiding hole.

10. The electrical connecting interface of a removable data storage device of claim 7, wherein the fixing section of the fixing unit comprises a stud.

11. The electrical connecting interface of a removable data storage device of claim 7, wherein the fixing section of the fixing unit comprises a machined thread.

12. The electrical connecting interface of a removable data storage device of claim 7, wherein the fixing section of the fixing unit comprises an embedding nut.

13. The electrical connecting interface of a removable data storage device of claim 8, wherein the fixing element comprises a screw.

14. The electrical connecting interface of a removable data storage device of claim 1, wherein the electrical connector further comprises a guiding stud.

15. The electrical connecting interface of a removable data storage device of claim 1, wherein the data storage unit is a hard disk, a floppy disk, or an optical disk drive.

16. The electrical connecting interface of a removable data storage device of claim 1, wherein the host computer is a personal computer, an industrial server, or an electric appliance.
